(19) United States
(12) Patent Application Publication
(10) Pub. No.: US 2016/0374382 A1
(43) Pub. Date: Dec. 29, 2016

(54) Encapsulated Calcium Source in Combination With A Biocompatible Polymer in Food

(71) Applicant: Balchem Corporation, New Hampton, NY (US)

(72) Inventors: Laura E. Hill, Saint Louis, MO (US); Robert Paul Mason, Maryland Heights, MO (US); Megan Michelle Maenius, Maryland Heights, MO (US); Bob Jay Dull, Akron, OH (US); Kristine Victoria Lukasik, New Hampton, NY (US)

(73) Assignee: Balchem Corporation, New Hampton, NY (US)

(21) Appl. No.: 15/171,871

(22) Filed: Jun. 2, 2016

Related U.S. Application Data
(60) Provisional application No. 62/171,600, filed on Jun. 5, 2015.

(51) Int. Cl. A23L 33/16; A23L 29/256; A23L 7/109

(52) U.S. Cl. CPC A23L 33/16; A23L 7/109; A23L 29/256; A23V 2002/00

(57) ABSTRACT

The present disclosure relates to food compositions and methods of preparing the same containing an encapsulated calcium source and a biocompatible polymer. In particular, the present disclosure relates to an improved pasta dough and a method of preparing the same containing an encapsulated calcium salt and an alginate. The encapsulated calcium source and biocompatible polymer can be used for the partial or complete replacement of whole eggs or egg whites in pasta.

### CROSS-REFERENCE TO RELATED APPLICATION

The present application claims priority benefit to a provisional patent application entitled “Encapsulated Calcium Source in Combination with a Biocompatible Polymer in Food,” which was filed on Jun. 5, 2015, and assigned Ser. No. 62/171,600. The entire content of the foregoing provisional patent application is incorporated herein by reference.

### FIELD OF THE INVENTION

The present disclosure relates to food compositions and methods of preparing the same containing an encapsulated calcium source and a biocompatible polymer. In particular, the present disclosure relates to improved pasta and pasta dough and a method of preparing the same containing an encapsulated calcium salt and an alginate. The encapsulated calcium source and biocompatible polymer can be used as a partial or complete replacement of whole eggs or egg whites in food, e.g., pasta.

### BACKGROUND OF THE INVENTION

Foods, such as pasta, traditionally require eggs and/or additional egg whites to strengthen the food formulation during and/or after cooking. Without eggs, the food may not be able to maintain a firm texture. Increasing egg prices have prompted food manufacturers to seek alternate ingredients which strengthens food formulations, or food compositions, at a reduced cost.

### SUMMARY OF THE INVENTION

The present disclosure relates to food compositions and methods of preparing the same containing an encapsulated calcium source and a biocompatible polymer.

In one embodiment, the present disclosure relates to a composition including an encapsulated calcium salt, alginate and a pasta dough. The calcium salt can be encapsulated in a biocompatible encapsulation material that can remain stable and not breakdown or release the calcium salt under ambient conditions (e.g., room temperature), under mechanical stress, or combination thereof.

In another embodiment, the present disclosure relates to a method including adding an encapsulated calcium salt to a pasta dough, adding an alginate to the pasta dough, mixing the pasta dough to substantially uniformly distribute the encapsulated calcium salt and alginate throughout the pasta dough, and heating the mixed pasta dough to release the calcium salt. The released calcium ions can crosslink the alginate.

In another embodiment, the present disclosure relates to a food, a pasta or a pasta dough including a crosslinked biocompatible polymer or alginate substantially uniformly distributed throughout. The food, pasta or pasta dough can have an improved characteristics, such as improved firmness, improved work of shear, or both compared to food, pasta or pasta dough wherein the crosslinked biocompatible polymer or alginate is not substantially uniformly distributed throughout.

The present disclosure can be used as an alternate stabilizing system in foods, such as pasta, to replace whole eggs or egg whites. In particular, whole eggs or egg whites can be partially or completely replaced in a food by a biocompatible crosslinked polymer gel, e.g., an alginate gel crosslinked with encapsulated calcium ions, that forms upon heat treatment. The introduction of an encapsulated calcium ion source can delay the formation of the biocompatible crosslinked polymer gel, e.g., alginate gel, until the encapsulated calcium source is distributed substantially uniformly throughout the food formulation.

The inclusion of an encapsulated calcium source that can release upon heat treatment can allow for the use of current manufacturing process without the need for process changes or modified equipment. For example, pasta dough containing alginate is commonly cooked in a calcium salt bath, in a modified manufacturing process, to crosslink the alginate at the surface. The present disclosure can replace the need for cooking foods, e.g., pasta, in a calcium rich bath to crosslink the biocompatible polymer, e.g., alginate. In particular, it can allow the use of current pasta manufacturing processes to produce a pasta having reduced amounts of egg content. Finally, the use of an alginate gel cross-linked with an encapsulated calcium lactate in cooked pasta as an egg replacement exhibits the same, or enhanced, flavor or texture.

### BRIEF DESCRIPTION OF THE DRAWINGS

The foregoing and other features and advantages provided by the present disclosure will be more fully understood from the following description of exemplary embodiments when read together with the accompanying drawings, in which:

FIG. 1 shows the results of a firmness test on pasta samples as described in Example 1.

FIG. 2 shows the results of a work of shear test on pasta samples as described in Example 1.

FIGS. 3, 4 and 5 show the results of hardness, stickiness and toughness tests on pasta dough samples as described in Example 1.

FIGS. 6 and 7 show the results of drying time on pasta samples as described in Example 1.

FIG. 8 shows the results of cook time on pasta samples as described in Example 1.

FIG. 9 shows the nutritional content of the pasta samples in Example 1.

FIGS. 10, 11 and 12 show the color, water absorption, moisture content, water activity and pH results of the pasta samples in Example 1.

FIGS. 13 and 14 show the consumer sensory test results on the pasta samples in Example 1.

FIGS. 15, 16, 17, 18, 19, 20, 21 and 22 show the pre hot hold firmness, pre hot hold work of shear, hot hold firmness and hot hold work of shear test result for the pasta samples in Example 2.

FIG. 23 shows the hot hold firmness test summary for the pasta samples in Example 2.

FIG. 24 shows the water absorption test results for the pasta samples in Example 2.

FIG. 25 shows the additional water absorption from hot hold test results for the pasta samples in Example 2.

FIG. 26 shows the pasta pH after hot holds test results for the pasta samples in Example 2.

FIG. 27 shows the water activity and moisture content after hot holds test results for the pasta samples in Example 2.

FIG. 28 shows the results of a dose response test on firmness for pasta samples in Example 2.

FIG. 29 shows a doneness test using Braibianti Pinchers for pasta samples in Example 1.

### DETAILED DESCRIPTION OF THE INVENTION

The present disclosure relates to food compositions and methods of preparing the same containing an encapsulated calcium source and a biocompatible polymer.

In one embodiment, the present disclosure relates to a composition including at least one encapsulated calcium salt, at least one biocompatible polymer and a food ingredient. In particular, the present disclosure relates to a composition including at least one encapsulated calcium salt, at least one alginate and pasta, pasta dough or a pasta ingredient.

The calcium salt can be any calcium salt that is biocompatible with food products, generally regarded as safe (GRAS) and can crosslink the biocompatible polymer. The calcium salt can be selected from, but is not limited to, the group consisting of calcium chloride, calcium lactate, calcium lactate gluconate, dicalcium phosphate (i.e., calcium monohydrogen phosphate or dibasic calcium phosphate), calcium sulfate, calcium carbonate, calcium acetate and combinations thereof. In particular, the calcium salt can be calcium lactate. In one embodiment, the lactate can enhance the flavor and functionality performance in food.

In some embodiments, another divalent cation can be used in place of a calcium salt, such as a divalent metal cation including magnesium, sodium or potassium.

The amount of calcium salt(s) in the composition can vary based on the amount of polymer present, the encapsulation coating, the food formulation, related manufacturing processes, etc. The amount of calcium salt(s) in the composition can be greater than about 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9 or about 5.0 wt %. These values can define a range, such as about 0.1 to about 0.5 wt %. The amount of calcium salt(s) in the composition can define a range, such as from about 0.2 to about 0.8 wt %, or about 0.01 to about 5.0 wt %.

The calcium salt can be encapsulated with any biocompatible encapsulation material. The biocompatible encapsulation material can be selected from but not limited to hydrogenated vegetable oil (e.g., palm, cottonseed, soy, sunflower) and distilled monoglyceride(s), diglyceride(s), triglyceride(s) or combinations thereof.

The calcium salt can be encapsulated to delay the release or interaction of the calcium ions with the biocompatible polymer, and other food ingredients, contained in the food. To delay the release or interaction, the calcium salt can be coated with a biocompatible encapsulation material having a minimum thickness. The average thickness of the biocompatible encapsulation material can be greater than about 0.005, 0.010, .015, .02, 0.025, 0.03, 0.035, 0.04, 0.045, 0.05, 0.055, 0.06, 0.065, 0.07, 0.075, 0.08, 0.085, 0.09, 0.095, 0.1, 0.105, 0.11, 0.115, 0.12, 0.125, 0.13, 0.135, 0.14, 0.145, 0.15, 0.16, 0.17, 0.18, 0.19, 0.2, 0.3, 0.4 or about 0.5 mm. These values can define a range, such as about 0.1 to about 0.2. The average thickness of the biocompatible encapsulation material can define a range, such as from about 0.005 to about 0.125 mm, or about 0.005 to about 0.400 mm.

The encapsulated calcium salt can remain stable in various environments and under various conditions without releasing the calcium. For example, the encapsulated calcium salt can remain stable at ambient temperatures. In particular, the encapsulated calcium salt can remain stable at temperatures up to about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59 or about 60° C. These values can define a range, such as about 10 to about 30° C. In particular, the encapsulated calcium salt can remain stable at temperatures in a defined range, such as from about 10° C. to about 50° C., or about 0° C. to about 60° C.

The encapsulated calcium salt can remain stable under the physical forces (e.g., shear forces) during standard mixing, blending and agitation steps in food manufacturing processes. In particular, the encapsulated calcium salt can remain stable under shear forces up to about 50, 75, 100, 125, 150, 175, 200, 225, 250, 275, 300, 350, 400, 450 and about 500 RPM. These values can define a range, such as about 75 to 200 RPM. In particular, the encapsulated calcium salt can remain stable under shear forces in a range, such as from about 10 to about 200 RPM, or about 0 to about 500 RPM.

The encapsulated calcium salt can remain stable when combined in either wet and/or dry food formulations during standard manufacturing processes. In some embodiments, the encapsulated calcium salt is sensitive to aqueous conditions and may release the sodium salt. The encapsulated calcium salt can remain stable when combined in either wet and/or dry food formulations during standard manufacturing processes and can remain stable in a wet food formulation for up to 0.5, 1, 2, 3, 4, 5 or about 6 hours. These values can define a range, such as from about 1 to 3 hours, or about 0 to about 4 hours. The encapsulated calcium salt is not sensitive to pH conditions.

In some embodiments, the encapsulated calcium salt can include, but is not limited to, additives, such as a surfactant, to increase the release of the calcium salt. In other embodiments, the encapsulated calcium salt, the food composition, or both, do not include an additive, such as a surfactant, to increase the release of the calcium salt.

The encapsulated calcium salt can include, but is not limited to, a calcium salt(s) and a biocompatible encapsulation material. The amount of biocompatible encapsulation material in the encapsulated calcium salt composition can be greater than about 1, 2, 3, 4, 5, 10, 15, 20, 25, 30, 35, 40, 45, 50, 60, 70, 80 or about 90 wt %. These values can define a range, such as about 20 to about 70 wt %. The amount of biocompatible encapsulation material in the encapsulated calcium salt composition can define a range, such as from about 15 to about 50 wt %, or about 5 to about 90 wt %.

The biocompatible polymer can be any polymer (e.g., mixture of polymers, copolymer, etc.) that is biocompatible with food products, generally regarded as safe (GRAS) and can be crosslink by calcium ions. In particular, the biocompatible polymer can be, but is not limited to, a polymer that can be thermally irreversible polymer matrix when crosslinked with calcium ions. The biocompatible polymer can be selected from, but is not limited to, the group consisting of alginate, pectin, pectate, carrageenan, xanthan gum, deacylated gum and combinations thereof. In particular, the biocompatible polymer can be sodium alginate. In one embodiment, the sodium alginate forms a gel in the presence of calcium lactate. The gel can be substantially irreversible under temperature variations.

Alginate is a GRAS, biocompatible polysaccharide extracted from brown algae that can form a thermally irreversible polymer matrix when crosslinked with calcium ions. This polymer can provide strength and act as a replacement for eggs in various food applications, including pasta.

The amount of biocompatible polymer in the composition can vary based on the amount of calcium present, the food formulation, related manufacturing processes, the desired taste and texture of the food, etc. The amount of biocompatible polymer(s) in the composition can be greater than about 0.01, 0.05, 0.1, 0.13, 0.2, 0.25, 0.3, 0.35, 0.39, 0.4, 0.45, 0.5, 0.55, 0.6, 0.65, 0.7, 0.75, 0.8, 0.85, 0.9, 0.95 or about 1 wt %. These values can define a range, such as about 0.2 to about 0.7 wt %. The amount of biocompatible polymer(s) in the composition can define a range, such as from about 0.1 to about 0.4 wt %, or about 0.01 to about 1.0 wt %.

In some embodiments, the food composition or formulation contains a substantially small or insufficient amount of calcium ions, or other ions, that are capable of substantially crosslinking the biocompatible polymer before the encapsulated calcium salt is released.

The present disclosure is applicable to any food that can benefit from a crosslinked polymer gel distributed substantially uniformly throughout the food. For example, the present disclosure is applicable to pasta, and can be used as an whole egg or egg white replacement. For example, the present disclosure is applicable to oven ready, cold pasta, frozen meal, hot hold and retort applications.

In one aspect, the technology of the present disclosure can be used to provide a functional replacement of egg whites in pasta applications by using a blend of encapsulated calcium lactate and sodium alginate. The present disclosure can reduce the ingredient cost for food and pasta manufacturers. The present disclosure can be a safer alternative to whole egg, egg whites, and egg products by removing egg allergen with complete replacement. As a result, the food formulations can exhibit both similar and improved characteristics. For example, the present disclosure can provide a pasta dough and cooked pasta similar and/or improved characteristics, structure, texture or combinations thereof. Also, the presence of the crosslinked biocompatible polymer in the food formulation can provide similar consumer sensory testing results, including perceived texture and mouthfeel.

In another embodiment, the present disclosure relates to a method including adding an encapsulated calcium salt to a food formulation, adding a biocompatible polymer to the food formulation, mixing the food formulation wherein the encapsulated calcium salt and the biocompatible polymer are substantially uniformly distributed throughout the food formulation to form a mixed food formulation; and heating the food formulation wherein the calcium salt is released from encapsulation. The released calcium can crosslink the biocompatible polymer.

In particular, the present disclosure relates to a method including adding an encapsulated calcium salt to a pasta dough, adding an alginate to the pasta dough, mixing the pasta dough wherein the encapsulated calcium salt and alginate are substantially uniformly distributed throughout the pasta dough to form a mixed pasta dough; and heating the dried pasta wherein the calcium salt is released from encapsulation. The released calcium can crosslink the alginate.

The encapsulated calcium salt and the biocompatible polymer, e.g., alginate, can be added to the food composition, e.g., pasta dough, by known manufacturing processes or means. For example, these materials may be added by blending and low shear dry blending techniques. In some embodiments, high shear blending techniques can compromise the encapsulated calcium salt. In other embodiments, the dry ingredients are mixed together prior to adding water to prevent undesired gelation from occurring.

After one or more of the materials have been added, the food formulation, e.g., pasta dough, can be mixed by known manufacturing processes or means to distribute the encapsulated calcium salt, the biocompatible polymer, e.g., alginate, or both in the formulation. The formulation can be mixed until the material(s)s are substantially uniformly distributed throughout the food formulation. The formulation can be mixed using standard mixing instruments at speeds up to about 10, 25, 50, 75, 100, 125, 150, 175, 200, 225, 250, 275, 300, 350, 400, 450 and about 500 RPM. These values can also be used to define a range, such as from about 10 to about 250 RPM, or about 0 and about 500 RPM.

The mixed food formulation can be heated to release the calcium salt from the encapsulation material to allow the calcium ions to interact with and crosslink the biocompatible polymer. The mixed food formulation can be heated to a temperature greater than about 25, 26, 27, 28, 29, 30, 31, 32, 33, 34, 35, 36, 37, 38, 39, 40, 45, 50, 55, 60, 65, 70, 71, 72, 73, 74, 75, 76, 77, 78, 79, 80, 81, 82, 83, 84, 85, 86, 87 ,88, 89, 90, 91, 92, 93, 94, 95, 96, 97, 98, 99 or about 100° C. These values can also be used to define a range, such as from about 70 to about 100° C. The mixed food formulation can be heated to a temperature range from about 70 to about 100° C., or about 25 to about 100° C. The mixed food formulation can be heated for a time sufficient to allow a minimum about of the encapsulated calcium ions to release. The mixed food formulation can be heated for at least about 1, 2, 3, 4, 5, 6, 7, 8, 8.5, 9, 9.25, 9.5, 9.75, 10, 10.25, 10.5, 10.75, 11, 12, 13, 14, 15, 20, 25, 30, 45 or about minutes. These values can also be used to define a range, such as from about 9 to about 11 minutes. The mixed food formulations can be heated in a range from about 8 to about 12 minutes, or about 1 to about 45 minutes.

In another embodiment, the present disclosure relates to a food formulation (or food composition) including a crosslinked biocompatible polymer substantially uniformly distributed throughout the food formulation. The presence of the crosslinked biocompatible polymer in the food formulation can provide improved strength to the food formulation. For example, for pasta and related food formulations, the crosslinked biocompatible polymer can provide a food with a firmer texture. As used herein, “firmness” refers to the degree of resistance to the first bite or the force required to penetrate the pasta with a light knife blade, teeth, etc. Firmness can be testing using a texture analyzer or equivalent. The compositions and food formulations of the present disclosure can have a firmness of greater than about 50, 100, 150, 200, 250, 300, 350, 400, 450, 500, 550, 600, 650, 700, 750, 800, 850, 900, 950 or about 1000 grams. These values can be used to define a range, such as about 500 to about 750 grams. The compositions and food formulations of the present disclosure can have a firmness in a range from about 500 to about 1700 grams, or about 200 to about 1800 grams.

The firmness of food compositions having a substantially uniformly distributed crosslinked biocompatible polymer of the present disclosure is about 10%, 15%, 20%, 25%, 30%, 35%, 40%, 45%, 50%, 55%, 60%, 65%, 70%, 75%, 80%, 85%, 90%, 95%, or about 100% greater than the firmness of a similar composition not containing the substantially uniformly distributed crosslinked biocompatible polymer of the present disclosure. These values can also define a range, such as about 20% to about 100%. The firmness of food compositions having a substantially uniformly distributed crosslinked biocompatible polymer of the present disclosure can define a range of about 10% to about 100% greater than the firmness of similar composition not containing the substantially uniformly distributed crosslinked biocompatible polymer of the present disclosure.

For pasta and related food formulations, the crosslinked biocompatible polymer can also provide a food with an improved work of shear. As used herein, “work of shear” refers to the amount force (in grams) needed to shear through the pasta per centimeter. Work of shear can be testing using a texture analyzer or equivalent. The compositions and food formulations of the present disclosure can have a work of shear greater than about 20, 30, 40, 50, 60, 70, 80, 90, 100, 110, 120 or about 130 gram/sec. These values can be used to define a range, such as about 50 to about 90 grams/sec. The compositions and food formulations of the present disclosure can have a work in a range from about 50 to about 90 grams/sec, or about 20 to 170 grams/sec.

The work of shear of food compositions having a substantially uniformly distributed crosslinked biocompatible polymer of the present disclosure is about 10%, 15%, 20%, 25%, 30%, 35%, 40%, 45%, 50%, 55%, 60%, 65%, 70%, 75%, 80%, 85%, 90%, 95%, 100%, 105%, 110%, 115%, 120%, 125%, 130%, 135%, 140%, 145%, or about 150% greater than the work of shear of a similar composition not containing the substantially uniformly distributed crosslinked biocompatible polymer of the present disclosure. These values can also define a range, such as about 40% to about 135%. The work of shear of food compositions having a substantially uniformly distributed crosslinked biocompatible polymer of the present disclosure can define a range from about 40% to about 135%, or about 10%, to about 150% greater than the work of shear of similar composition not containing the substantially uniformly distributed crosslinked biocompatible polymer of the present disclosure.

The disclosures of all cited references including ASTM methods, publications, patents, and patent applications are expressly incorporated herein by reference in their entirety.

When an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

The present invention is further defined in the following Examples. It should be understood that these Examples, while indicating preferred embodiments of the invention, are given by way of illustration only.

### EXAMPLES

### Example 1

Pasta samples were prepared containing the encapsulated calcium source and a biocompatible polymer of the present disclosure as both a partial and a complete replacement of whole eggs and egg whites and tested against a variety of control samples. Table 1 shows a list of the pasta samples.

TABLE 1
Pasta Samples Tested

| | |
|---|---|
| Control | Pasta with 1.31 wt % egg white |
| Raw 50% | Pasta with 0.67 wt % egg white, raw calcium lactate, |
| | and sodium alginate |
| Raw 100% | Pasta with 0 wt % egg white, raw calcium lactate, and |
| | sodium alginate |
| SA 50% | Pasta with 0.67 wt % egg white, and sodium alginate |
| | and when cooked-cooked in water |
| SA 100% | Pasta with 0 wt % egg white, and sodium alginate and |
| | when cooked-cooked in water |
| MS 50% | Pasta with 0.67 wt % egg white, encapsulated calcium |
| | salt, and sodium alginate |
| MS 100% | Pasta with 0 wt % egg white, encapsulated calcium |
| | salt, and sodium alginate |
| SA w CL 50% | Pasta with 0.67 wt % egg white, and sodium alginate |
| | and when cooked-cooked in calcium lactate bath |
| SA w CL 100% | Pasta with 0 wt % egg white, and sodium alginate and |
| | when cooked-cooked in calcium lactate bath |

The control sample contained 1.31 wt % egg white. Pasta samples were prepared containing un-encapsulated calcium lactate and alginate. In these samples, and the remaining samples, the egg white was partially replaced (50%) or completely replaced (100%). These samples were designated as Raw 50% and Raw 100%. Pasta samples were also prepared without any calcium salt or ions added. These samples contained only alginate and were cooked in water. These samples were designated as SA 50% and SA 100%. Pasta samples were prepared according to the present disclosure containing encapsulated calcium salt and alginate. These samples are designated as MS 50% and MS 100%. Finally, pasta samples were prepared containing only alginate and were cooked in a calcium lactate bath. These samples were designated SA w CL 50% and SA w CL 100%.

pasta samples were prepared and cooked using standard pasta preparation techniques. For the pasta/dough preparation—The dries were added to a bowl and whisked together until uniform. In a separate bowl, the egg white and water were mixed until uniform. The liquid ingredients were poured into a MacDuffee mixing bowl attached to Hobart A-120 mixer. The dry ingredients were added to the liquid mixture. The mixture was mixed on speed 1 for 1 minute, then on speed 2 for 3 minutes. The dough was removed from the bowl and rounded into a ball. The dough was wrapped tightly in plastic wrap and refrigerated for approximately 1 hour. The dough was removed from refrigerator and rested for 15 minutes. The dough was cut into 100 g pieces and covered. 100 g pieces were hand kneaded into flattened balls. Using the widest setting (e.g., 1 on the Kitchen Aid Pasta Attachment), the dough balls were fed through the rollers. The dough was folded in half and rolled again perpendicular to the crease of the fold. This was repeated 3 more times with light dusting of the sheet of pasta in between each rolling if any stickiness is observed. Adjustment knob was moved to setting 2 and the dough sheet was fed through the rollers once. Then, the adjustment knob was moved to setting 3 and the dough sheet fed through the rollers once. Using a chef's knife, the long dough sheet was cut into two shorter pieces. (Both sheets and fettuccine noodles were used. For sheets, the dough was placed immediately on the drying rack after sheeting and was not be passed through the fettuccine cutter. To cut each piece, the fettuccine cutter on the Kitchen Aid Pasta Attachment was used. The dough sheet was run through once. Immediately thereafter, the cut noodles were placed onto the drying rack to separate any noodles that stick together. Using scissors, the hanging noodles were cut perpendicular leaving about 4.55 inches between the end of the noodle and the drying rack on each side. This resulted in a noodle of around 9 inches. The noodles were dried overnight. After noodles were dry, they were broken at the bend in order to have noodles about 4.5″ in length.

The pasta was placed in about 3500 mL of water that was brought to a hard boil (about 25 minutes; between burner setting 9 and High). 100 g of dried pasta was added to the boiling water and boiled for the determined cooking time. Noodles were then immediately drained using a metal colander and transferred to a bowl of ice water (about 6.5° C. ±1.0) for 1 minute in order to stop the cooking process and drained immediately. The pasta ingredients and amounts are listed in Table 2.

TABLE 2
Pasta samples contents.

| | | Raw- | Raw- | SA- | SA- | MS- | MS- |
|---|---|---|---|---|---|---|---|
| | Control | 50% Egg | 100% Egg | 50% Egg | 100% Egg | 50% Egg | 100% Egg |
| Pasta | (wt %) | (wt %) | (wt %) | (wt %) | (wt %) | (wt %) | (wt %) |
| Semolina | 65.36% | 65.61% | 66.05% | 65.69% | 66.14% | 65.52% | 65.96% |
| Egg White | 1.31% | 0.67% | — | 0.67% | — | 0.67% | — |
| Water | 33.33% | 33.46% | 33.69% | 33.50% | 33.73% | 33.42% | 33.64% |
| Encapsulated | — | — | — | — | — | 0.26% | 0.26% |
| Calcium Salt | | | | | | | |
| Sodium | — | 0.13% | 0.13% | 0.13% | 0.13% | 0.13% | 0.13% |
| Alginate | | | | | | | |
| Calcium | — | 0.13% | 0.13% | — | — | — | — |
| Lactate | | | | | | | |
| Pentahydrate | | | | | | | |
| Total | 100.00% | 100.00% | 100.00% | 100.00% | 100.00% | 100.00% | 100.00% |

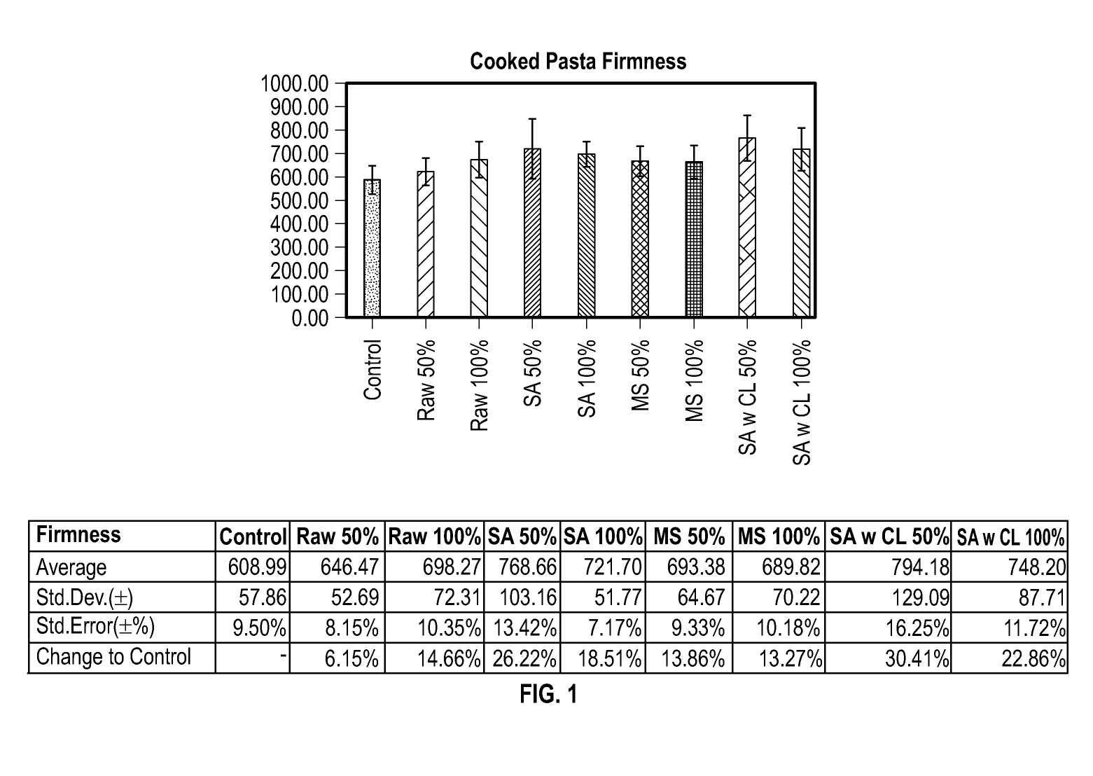

The cooked pasta samples were tested for firmness. A TA.TXT Texture Analyzer was used having a 5 Kg load cell. Three noodles were placed on the platform for analysis. The cooked pasta's firmness was analyzed. The height of the Light Knife Blade (TA-47) was calibrated to about 5 mm. The settings included a test speed of about 0.17 mm/sec, a post-test speed of about 10 mm/sec, and the probe travel set distance of about 4.5 mm on the probe. FIG. 1 shows the results of the cooked pasta firmness test. Pasta samples prepared according to the present disclosure, e.g., MS 50% and MS 100%, exhibited comparable firmness to other pasta preparation. The addition of an encapsulated calcium source and a biocompatible polymer of the present disclosure did not negatively affect texture-firmness.

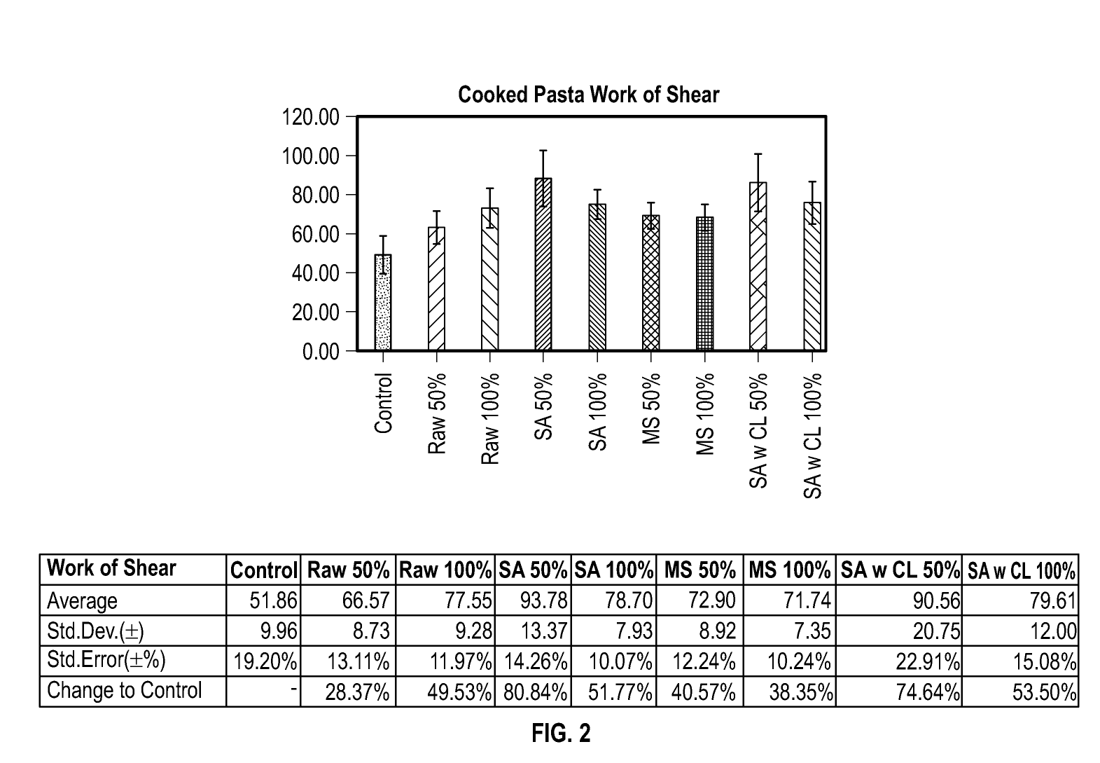

The cooked pasta samples were tested for work of shear. FIG. 2 shows the results of the cooked pasta work of shear test. Pasta samples prepared according to the present disclosure, e.g., MS 50% and MS 100%, exhibited comparable work of shear to other pasta preparation. The addition of an encapsulated calcium source and a biocompatible polymer of the present disclosure did not negatively affect these results.

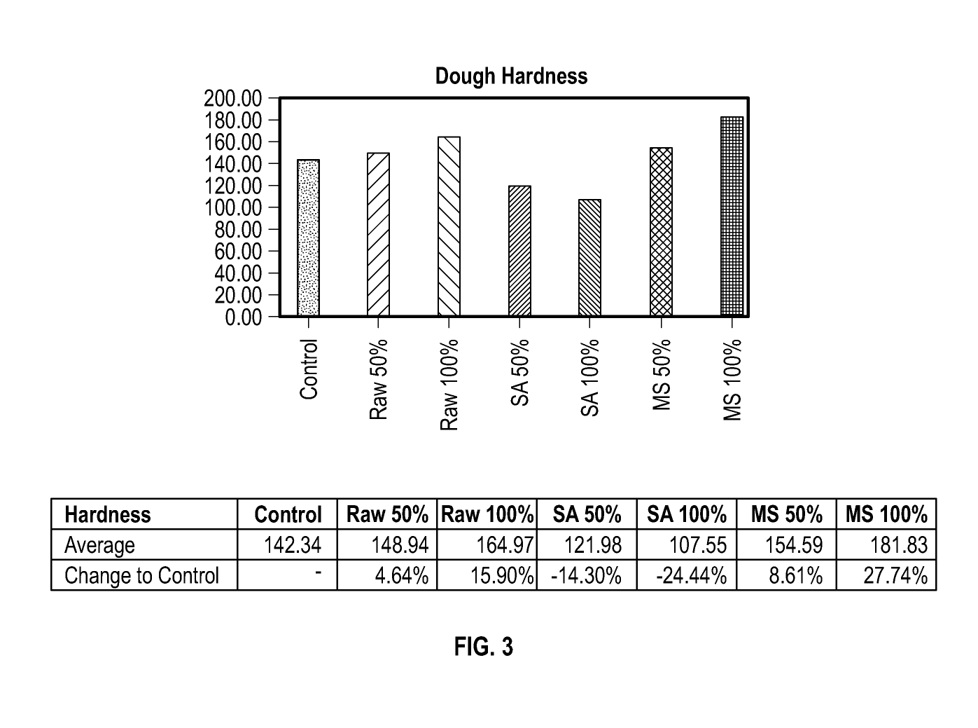

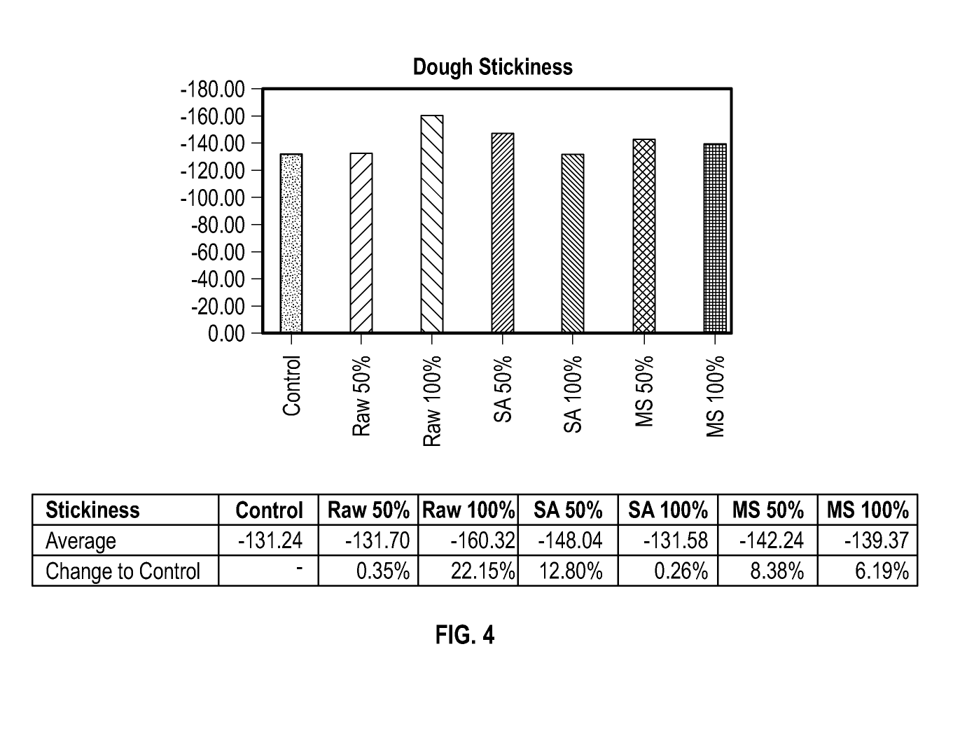

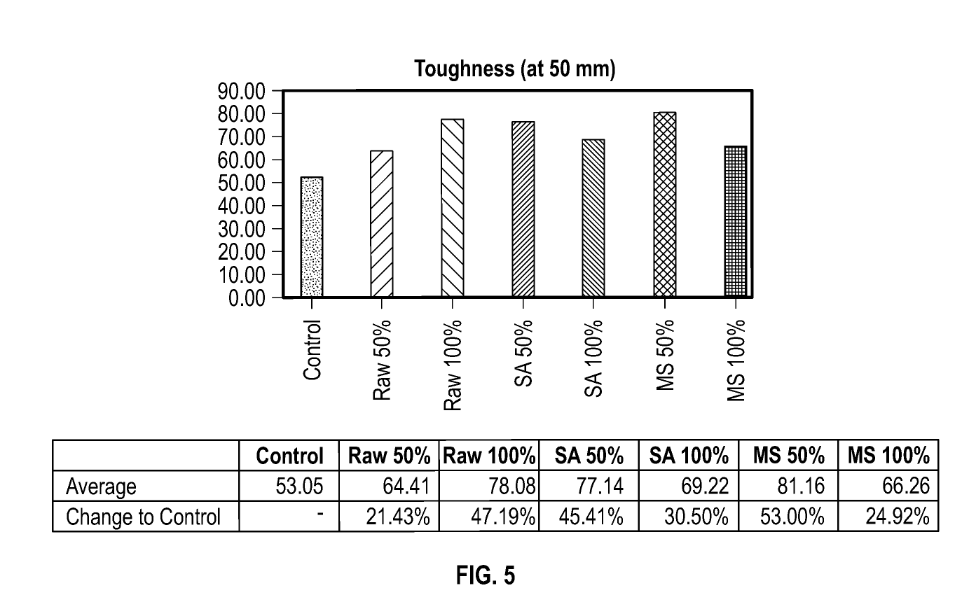

The pasta samples were formed into dough balls and sheets, and tested for hardness, stickiness and toughness. A TA.TXT Texture Analyzer was used having a 5 Kg load cell. About 100 grams of dough was rounded and placed in the test cell for the Miller Dough Set (TA-85) and then flattened the dough ball using the flattening plunger. Then, using the TA-23 probe, the dough's hardness and stickiness was analyzed. The height of the probe was calibrated to about 70 mm. The settings included a pre-test speed 1 mm/sec, a test speed 0.5 mm/sec, a post-test speed 10 mm/sec, and the probe travel set distance of 15 mm on the probe triggered by 3.0 grams of force. The dough's toughness was analyzed by placing a sheet of dough on a Large Film Extensibility Rig (TA-108N) without the plastic ring. The height of the probe was calibrated to about 35 mm. The settings included a pre-test speed 2 mm/sec, a test speed 1 mm/sec, a post-test speed 10 mm/sec, and the probe travel set distance of 50 mm on the probe is triggered by 5.0 grams of force. FIGS. 3-5 show the results of these tests. Pasta dough samples prepared according to the present disclosure, e.g., MS 50% and MS 100%, exhibited comparable hardness, stickiness and toughness to other pasta dough preparation. The addition of an encapsulated calcium source and a biocompatible polymer of the present disclosure did not negatively affect these results. There were no significant different between the texture attributes analyzed on the pasta dough samples.

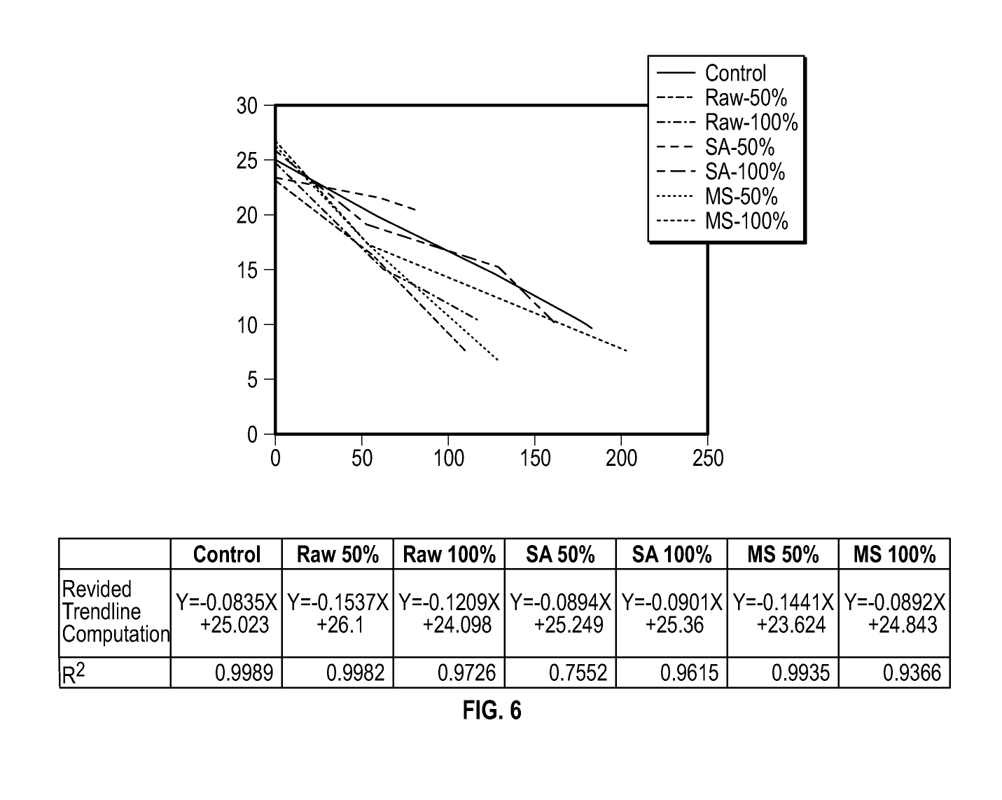

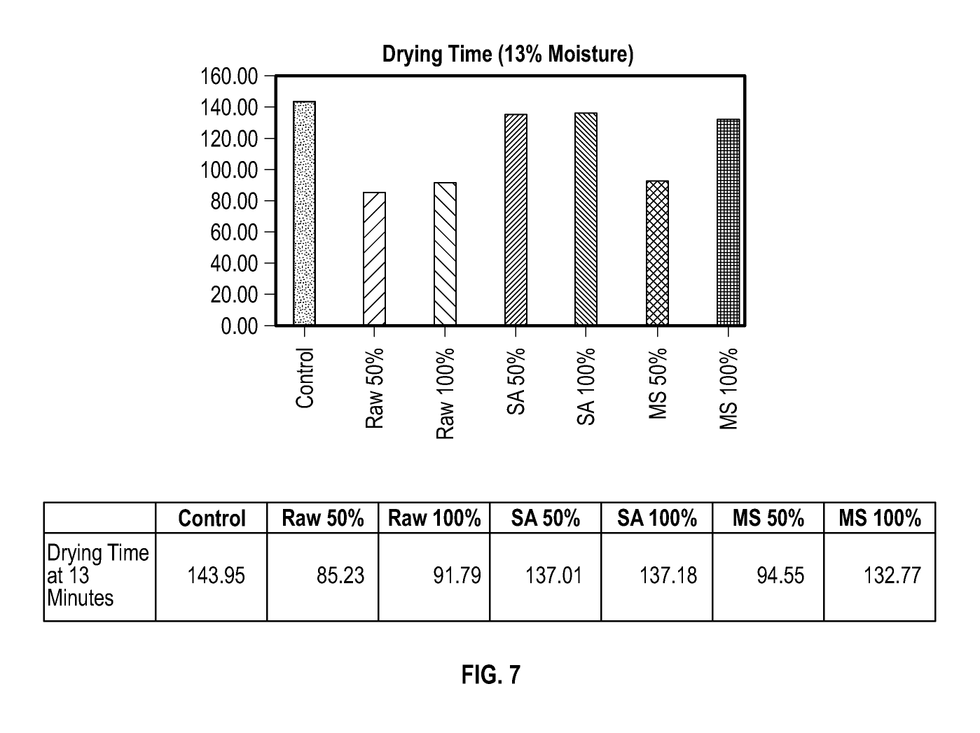

The pasta samples were tested for drying time. After the pasta dough was sheeted, cut and hung to dry, the moisture content was analyzed on at least 0.50 g of noodles using an Ohaus MB45 Moisture Analyzer. The noodles were tested approximately every hour until the pasta has reached about 12-13% moisture. The temperature and relative humidity was recorded at the time the moisture content was tested. Similar conditions, room temperature and relative humidity, for the room was maintained for each day the pasta was produced. FIGS. 6 and 7 show the results of this test. Pasta samples prepared according to the present disclosure, e.g., MS 50% and MS 100%, exhibited comparable drying time. FIG. 6 show the % moisture over time. All samples show a similar decrease in moisture content. FIG. 7 shows the time for each sample to decrease to 13% moisture. The addition of an encapsulated calcium source and a biocompatible polymer of the present disclosure did not negatively affect these results. The time required to dry the MS 50% and MS 100% was similar to the control.

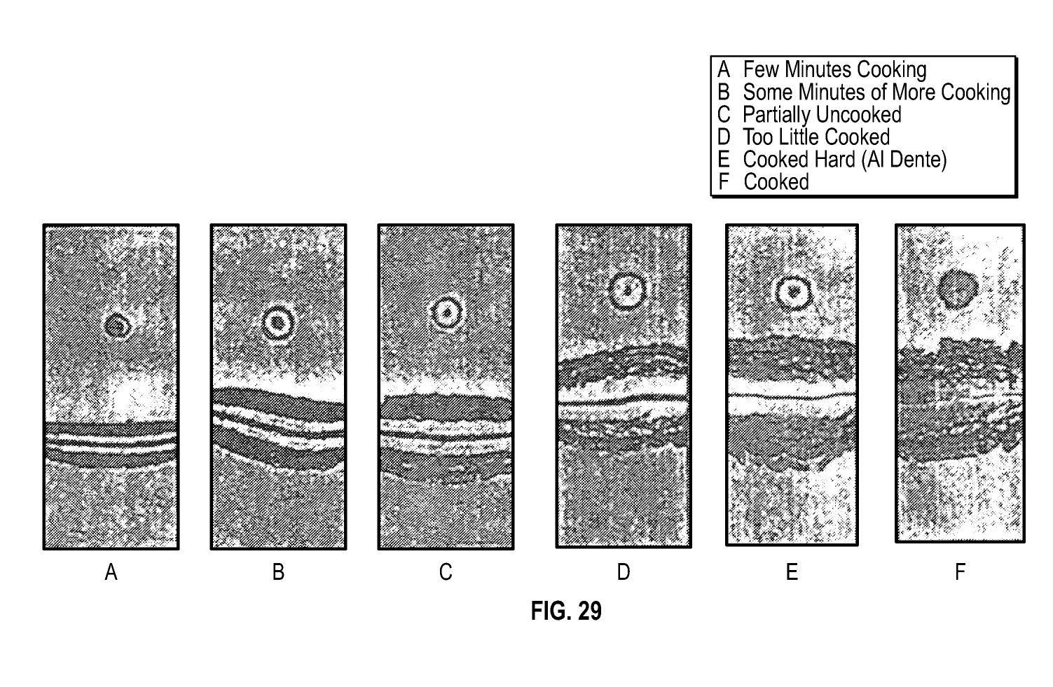

The pasta samples were tested for cook time. The pasta was placed in about 3500 mL of water that was brought to a hard boil (about 25 minutes; between burner setting 9 and High). 100 g of dried pasta was added to the boiling water and boiled for the determined cooking time. The timer begin when the pasta was added to the water and continued until a desired F doneness was achieved. Doneness was tested using Braibianti Pinchers. FIG. 29 shows a doneness test using Braibianti Pinchers. Noodles were then immediately drained using a metal colander and transferred to a bowl of ice water (about 6.5° C. ±1.0) for 1 minute in order to stop the cooking process and drained immediately.

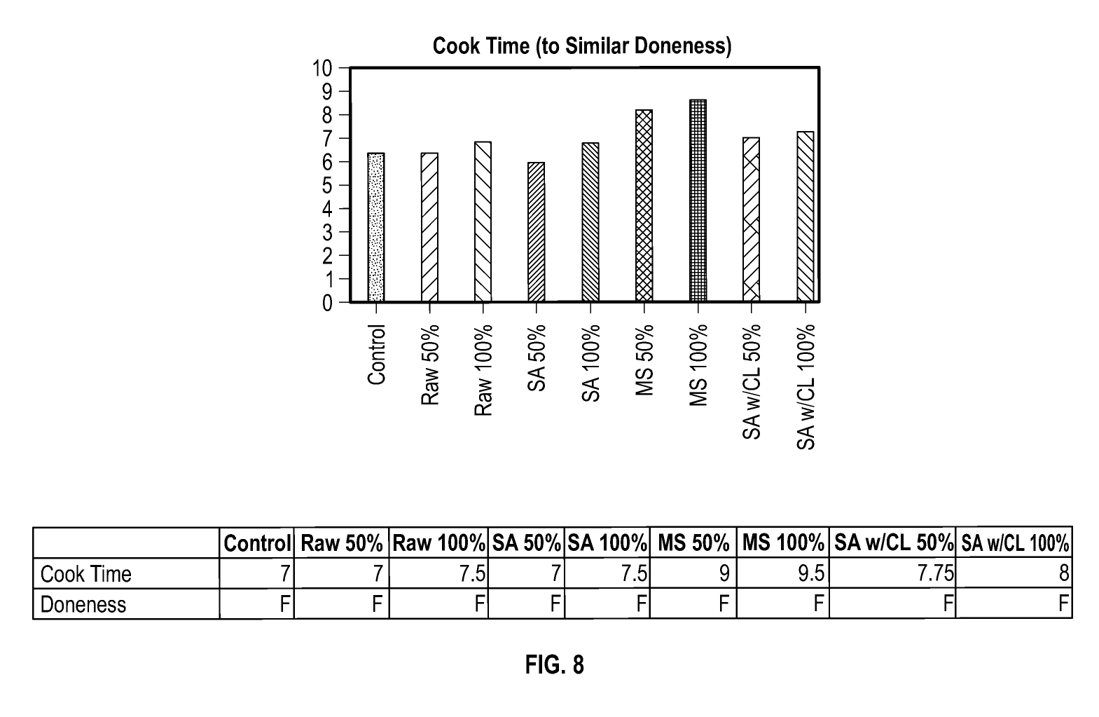

FIG. 8 shows the results of this test. Pasta samples prepared according to the present disclosure, e.g., MS 50% and MS 100%, exhibited extended cooking time compared to the control in order to achieve similar doneness. The extended cooking time needed can provide assistance in preventing the overcooking of the pasta by users. The increase in cooking time can also length the window for food to be properly cooked without overcooking.

For example, the window of time for dried pasta to be properly cooked at 100° C. can be between about 6-8 minutes. The window of time for dried pasta according to the present disclosure to be properly cooked at 100° C. can be between about 8-12 minutes or an increase of about 10%, 15%, 20%, 25%, 30%, 35%, 40%, 45%, 50%, 55%, or about 60%. These values can define a range, such as from about 20% to about 50%. The food formulation of the present disclosure can increase the window of time for dried pasta to be properly cooked can define a range from about 20% to about 60%, or about 5% to about 60%.

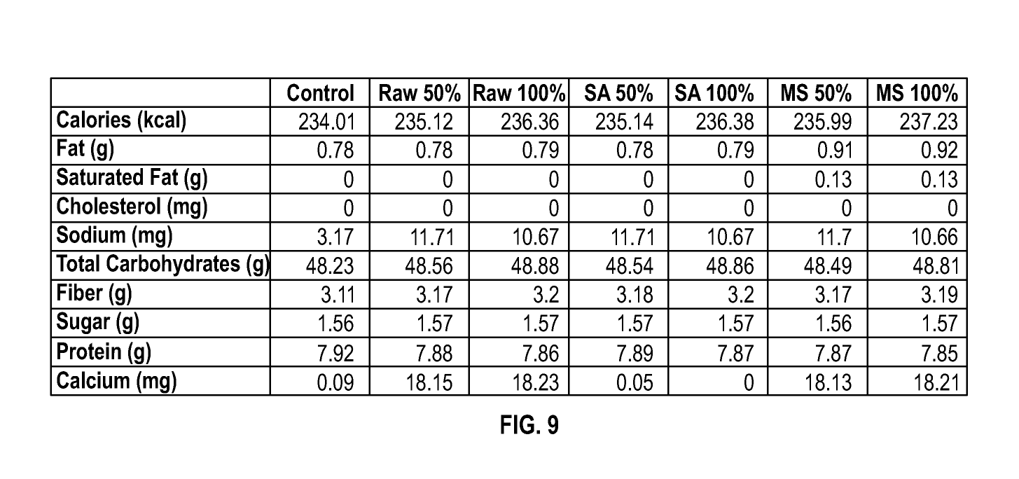

The pasta samples were analyzed for nutritional content. The nutritional content measured included total calories, fats, protein, sugar, etc. FIG. 9 shows the results of the nutritional analysis. Overall, all samples exhibited similar nutritional content with minor exceptions, such as of calcium content. The pasta samples were also tested for color, water absorption, moisture content, water activity and pH.

Water absorption was tested by weighing the dried pasta and recording the weight before placing it into boiling water. The cooked pasta was weighed and recorded after being drained from an ice water bath. Water absorption was calculated using the formula: Water absorption=[(Cooked Pasta−Dried Pasta)/Dried Pasta]×100. Color was tested using a HunterLab ColorFlex Colorimeter. The results were provided in L*, a* and b* values using the Colorimeter Color Program. The colorimeter was standardized using black and white plates. After it had been standardized, the standard plate was analyzed to check the standardization. After the colorimeter had been standardized, the cooked pasta sheet was placed on the viewing area and the color of the cooked pasta was measured. Three measurements were taken per sheet of cooked pasta. Additionally, opacity was also analyzed. First, the sample was read with the white plate over sample and then the sample was read with the black plate or light trap to obtain the opacity of the sample.

Water activity was measured using the AquaLab Series 3 water activity meter. A 0.50 g sample of pasta was taken from the cooked pasta. The sample was placed in an AquaLab disposable sample container and put in the water activity meter. The moisture content was measured using the Ohaus MB45 Moisture Analyzer. The aluminum weigh boat was tared while in the pan handler with the lid closed on the moisture analyzer. Approximately 0.50 g of pasta was weighed for analysis on the moisture analyzer. The lid was closed during testing. The pH of the pasta was measured using the Corning 440 pH meter. About 10.00 g of hot held pasta was combined with about 90.00 mL of distilled water and blended with a hand immersion blender for about 30 seconds. This mixture was mixed for about 2 minutes with a stir bar. Then, the pH will be measured.

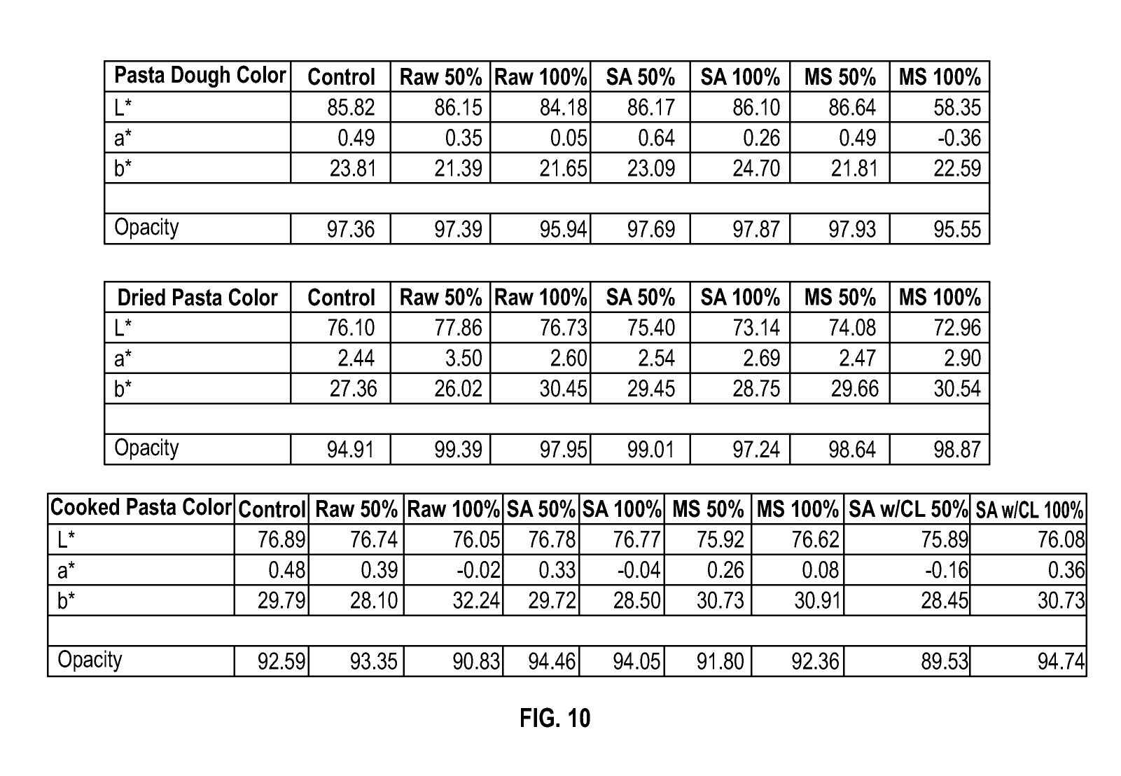

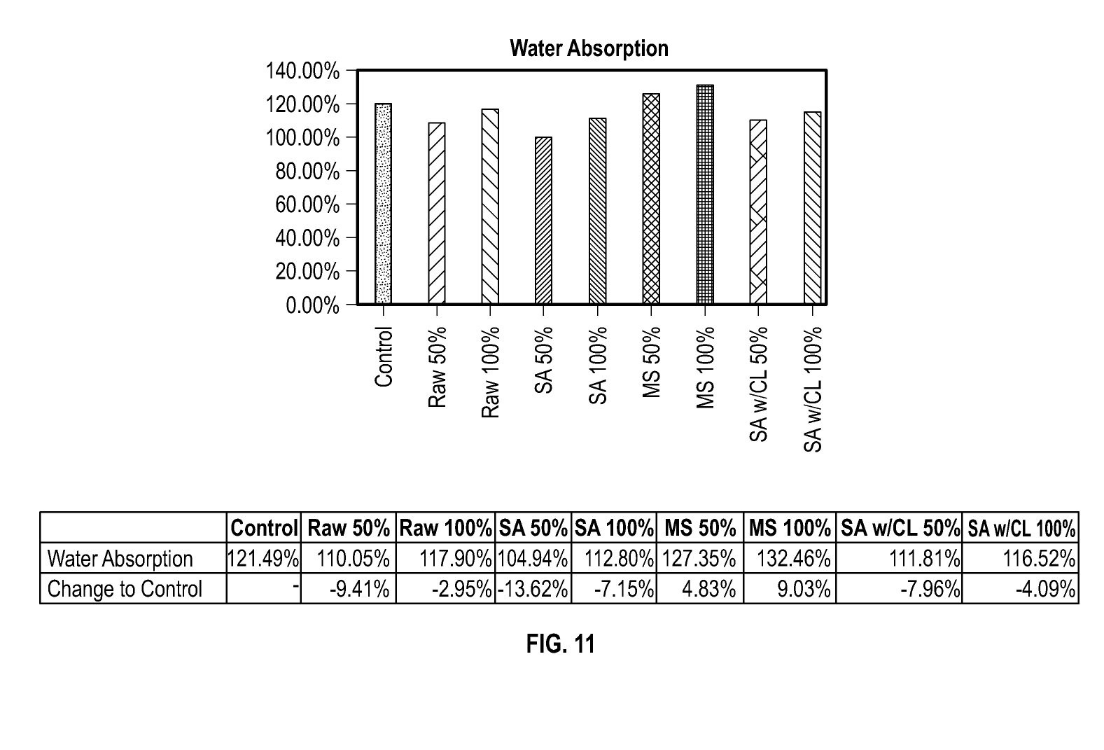

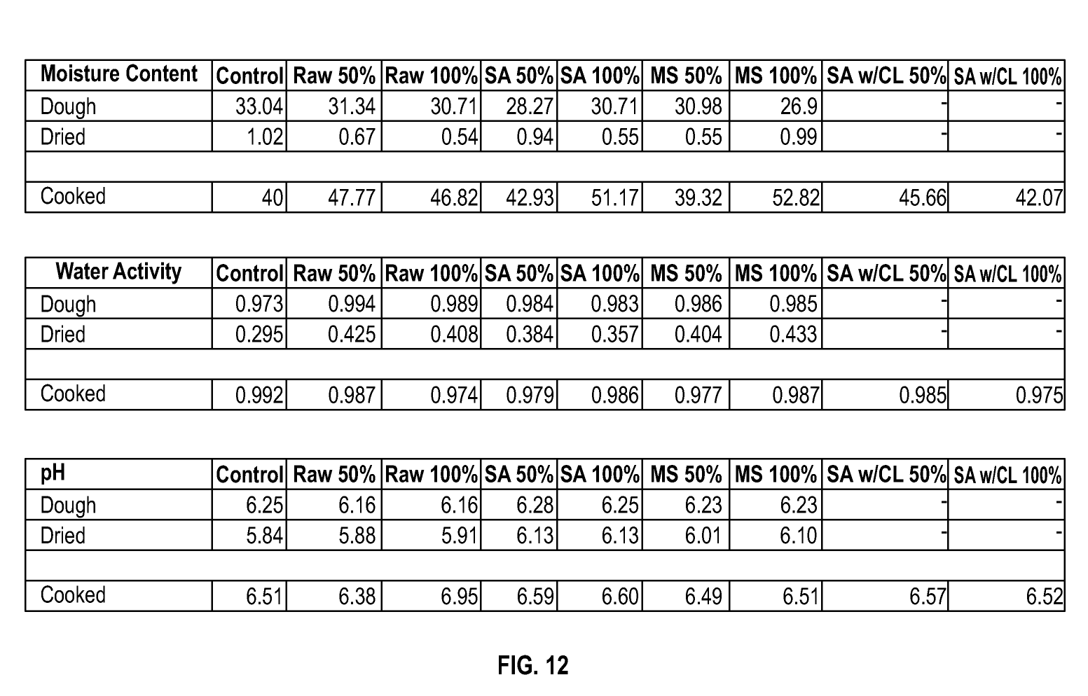

FIGS. 10-12 show the results of these tests. The addition of an encapsulated calcium source and a biocompatible polymer of the present disclosure did not negatively affect these results. There were also no significant differences between pH, water activity, moisture content, and color for the different pasta variables.

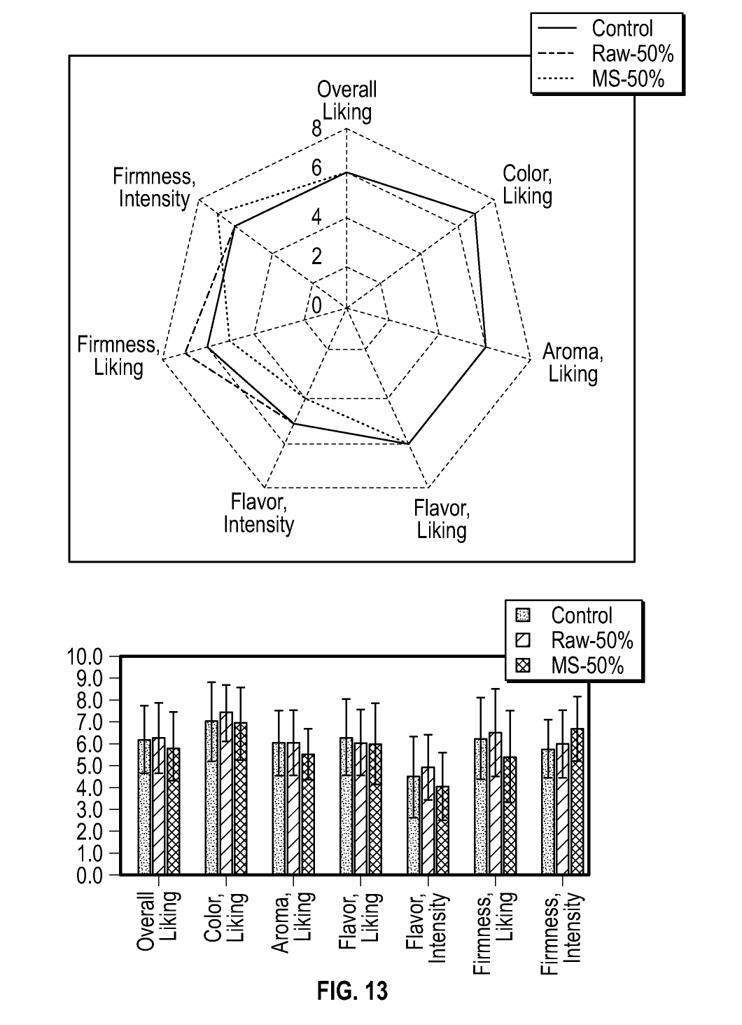

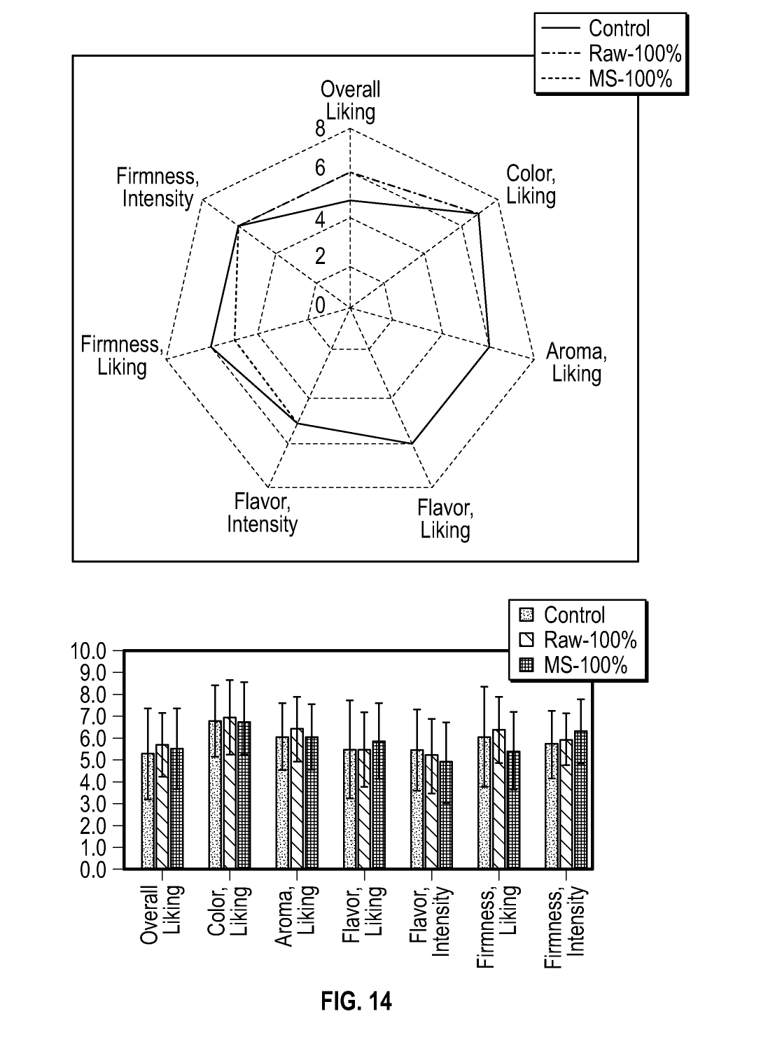

An overall consumer sensory test was performed on the pasta samples. The pasta was tossed in no more than 5% Bertolli Extra Virgin Olive Oil for the sensory testing. The sensory test included a measure for overall liking, color liking, aroma liking, flavor liking, flavor intensity, firmness liking and firmness intensity. FIGS. 13 and 14 show the sensory test results for 50% and 100% egg replacement. The addition of an encapsulated calcium source and a biocompatible polymer of the present disclosure did not negatively affect these results. There were no significant differences in consumer sensory tests for pasta samples.

### Example 2

The control, Raw 50%, Raw 100%, MS 50% and MS 100% samples were tested for pre hot hold firmness, pre hot hold work of shear, hot hold firmness and hot hold work of shear in various medium. For pre hot hold firmness testing, a TA.TXT Texture Analyzer was used and set up with the 5 Kg load cell. Three noodles were placed on the platform for analysis. The cooked pasta's firmness was analyzed. The height of the Light Knife Blade (TA-47) was calibrated to about 5 mm. The settings were a test speed of 0.17 mm/sec, a post-test speed of 10 mm/sec, and the probe travel set distance of 4.5 mm on the probe. For pre hot hold work of shear, the TA.TXT Texture Analyzer was also used. For hot hold firmness, the cooked pasta was tested after being held in the various medium using the TA.TXT Texture Analyzer. For hot hold work of shear, the cooked pasta was also tested after been held in various medium using the TA.TXT Texture Analyzer.

Hot hold refers to the pasta being held within the holding liquid in the oven at about 145° F. in a water bath for about 2 hours. The pasta samples were tested in the following holding liquids: Broth-Swanson Chicken Broth 33% less sodium, Red Sauce-Barilla Traditional Marinara Sauce, and White Sauce-Bertolli Alfredo Sauce. The holding liquid refers to the holding liquid only after an about 2 hour hot hold. The holding liquid was tested by being placed in a jar without pasta. The average cooked pasta refers to the average of all of the cooked pasta samples from Example 1. The Example 1 samples were not tested under hot hold conditions.

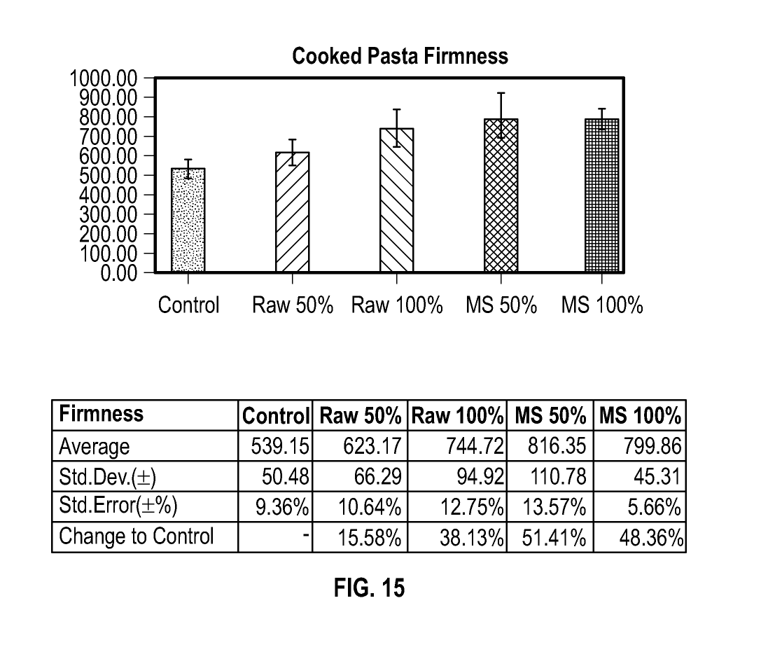

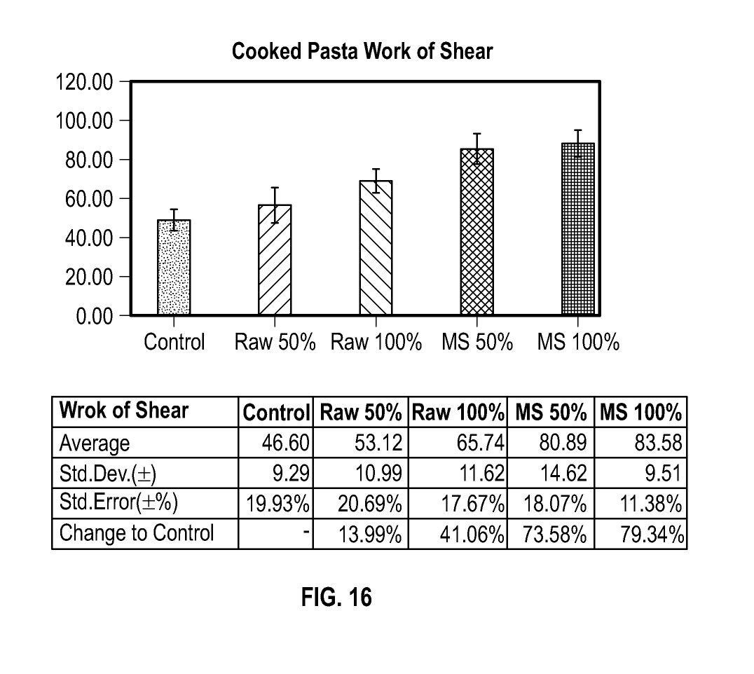

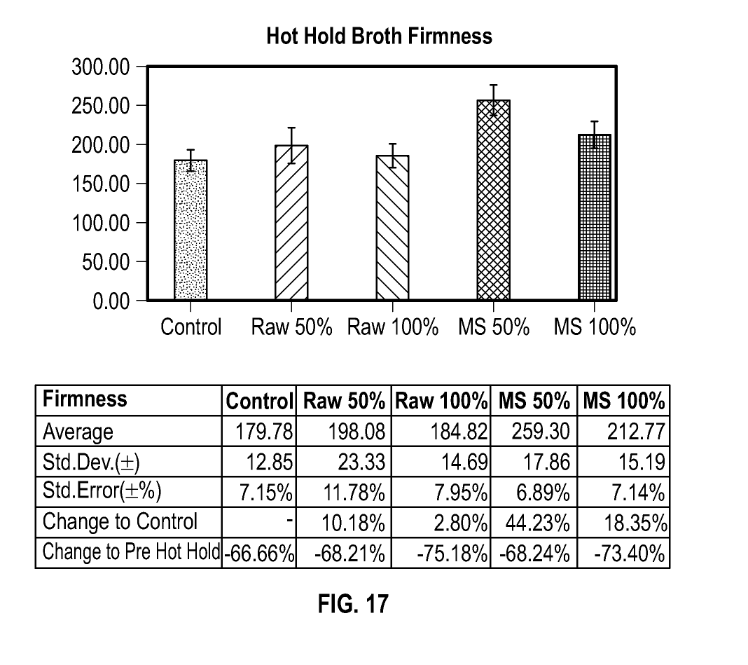

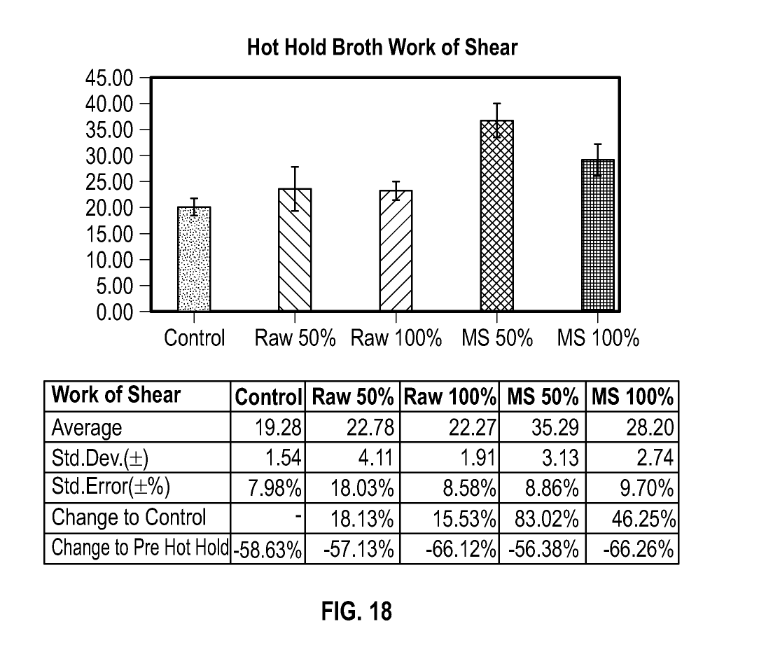

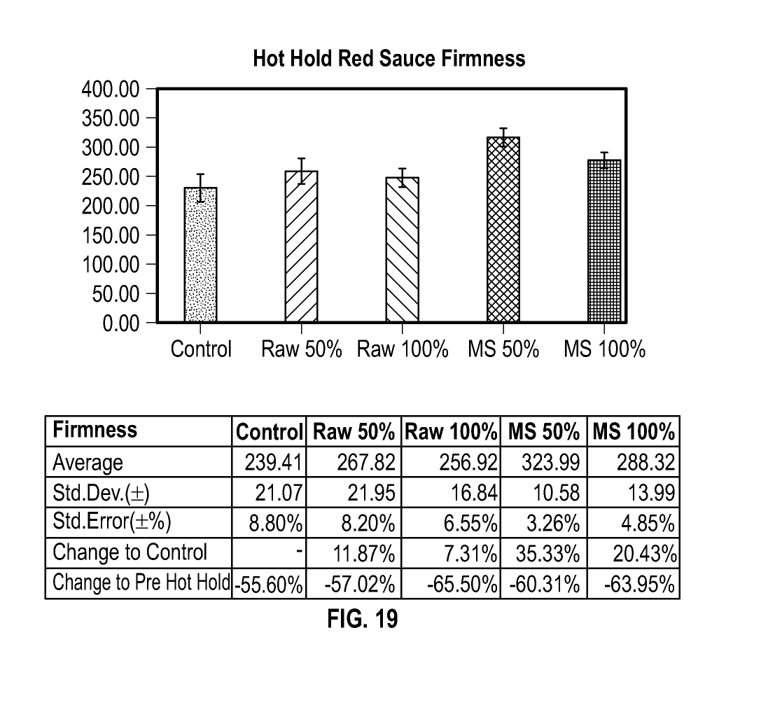

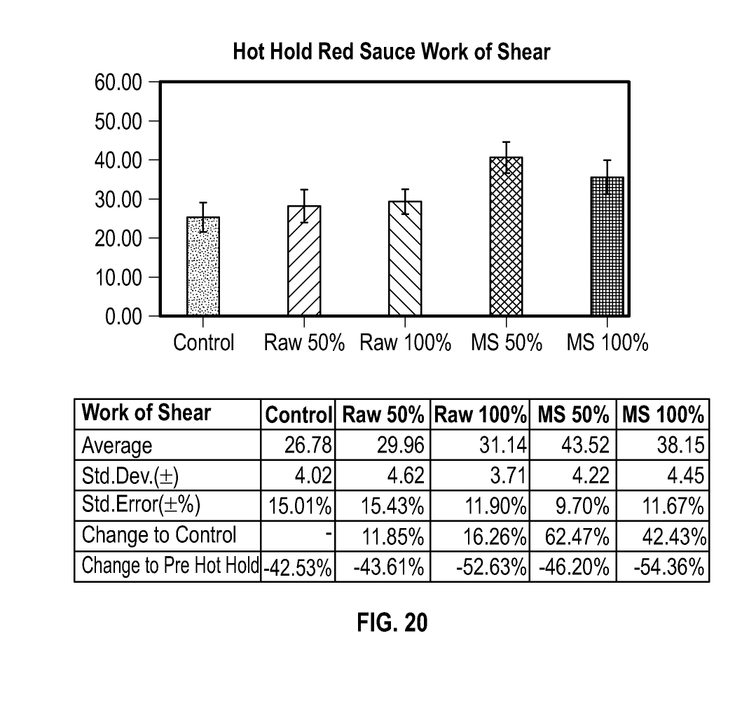

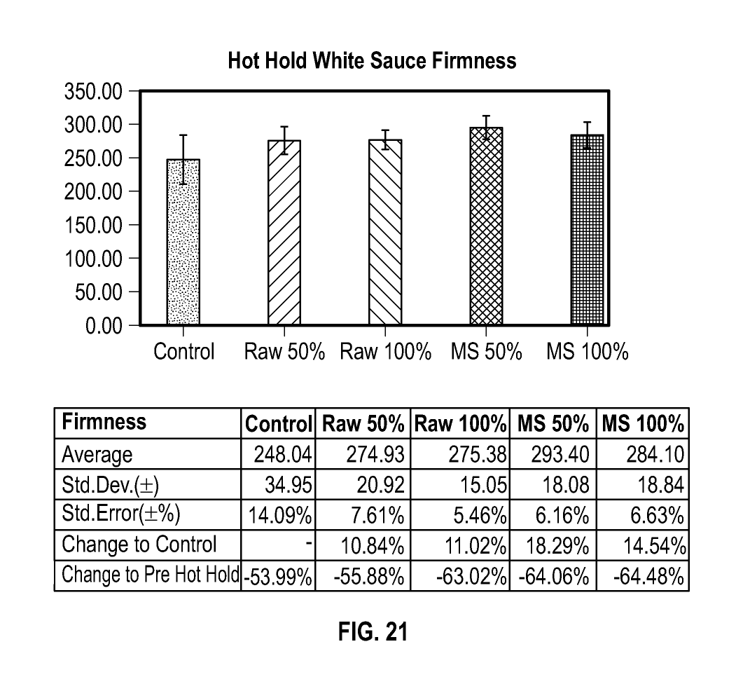

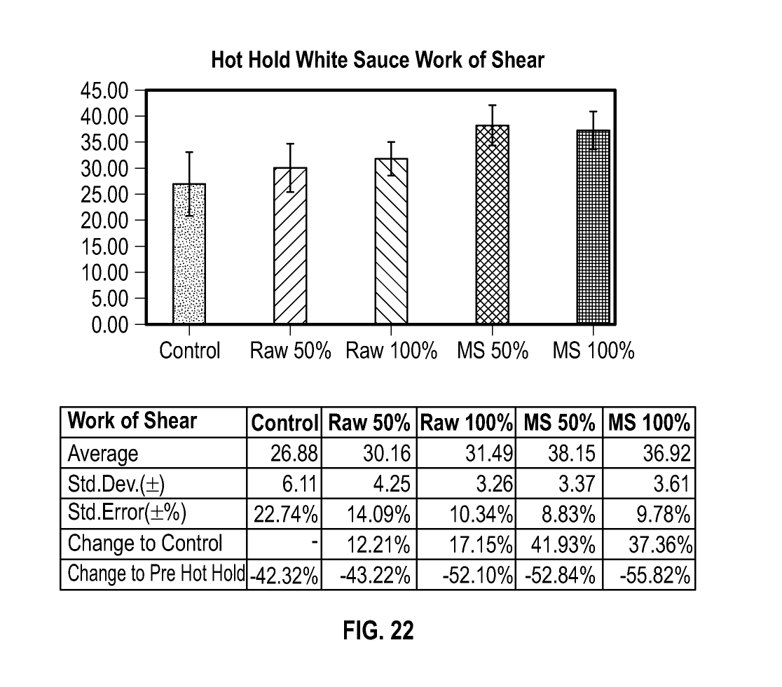

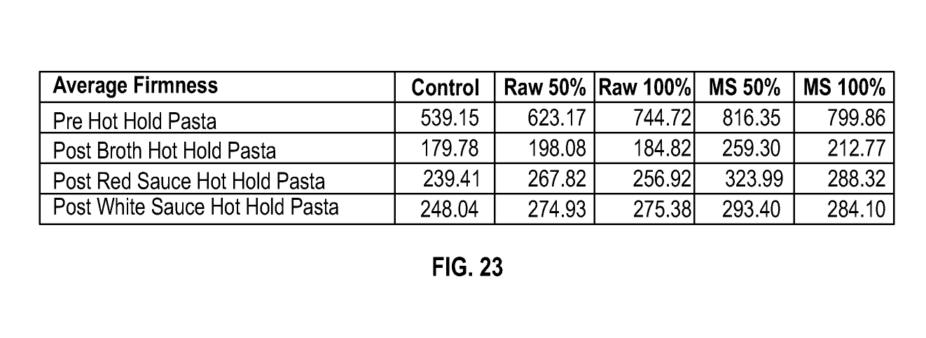

FIGS. 15-22 show the test results for the samples in both tests in the three holding liquids. Overall, both MS 50% and MS 100% samples maintained a firmer texture through cooking and hot hold processes containing broth and red marinara sauce compared to the control. Minimal variation was found between the different variables in the hot hold process containing white alfredo sauce. The results are summarized in FIG. 23.

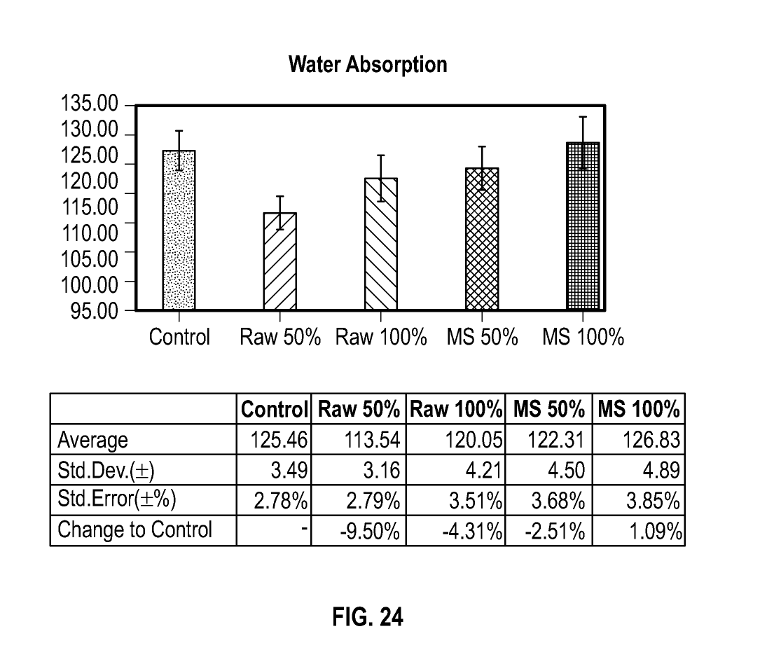

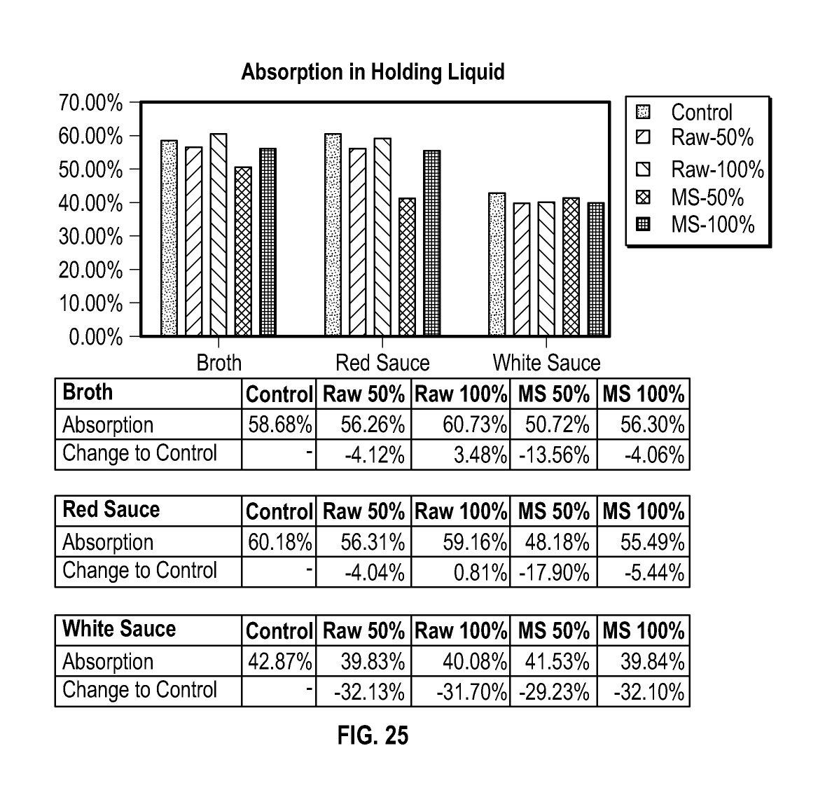

The pasta samples were tested for water absorption. FIGS. 24 and 25 show the results of these tests for water absorption throughout all (FIG. 24) and additional absorption from hot hold (FIG. 25). Water absorption was tested by weighing the dried pasta and recording the weight before placing it into boiling water. The cooked pasta was weighed and recorded after being drained from an ice water bath. Water absorption was calculated using the formula: Water absorption=[(Cooked Pasta−Dried Pasta)/Dried Pasta]×100. Additional absorption for the hot hold was tested by weighing the cooked pasta and recording the weight before placing it into the holding medium. The pasta was held in holding medium for 2 hours. After the 2 hours elapsed, the pasta was weighed and the weight recorded after being drained from the holding medium. Additional absorption was calculated using the formula: Additional absorption=[(Hot Hold Pasta−Cooked Pasta)/Cooked Pasta]×100. It was found that the MS 50% and MS 100% samples have the ability to absorb a similar amount of water compared to the control. In one aspect, the water absorption properties could lead to increased yields for the customer. Since the pasta can absorb more water, the weight of the pasta can increase. Therefore, less pasta can be needed in order to meet the weight needed for a serving.

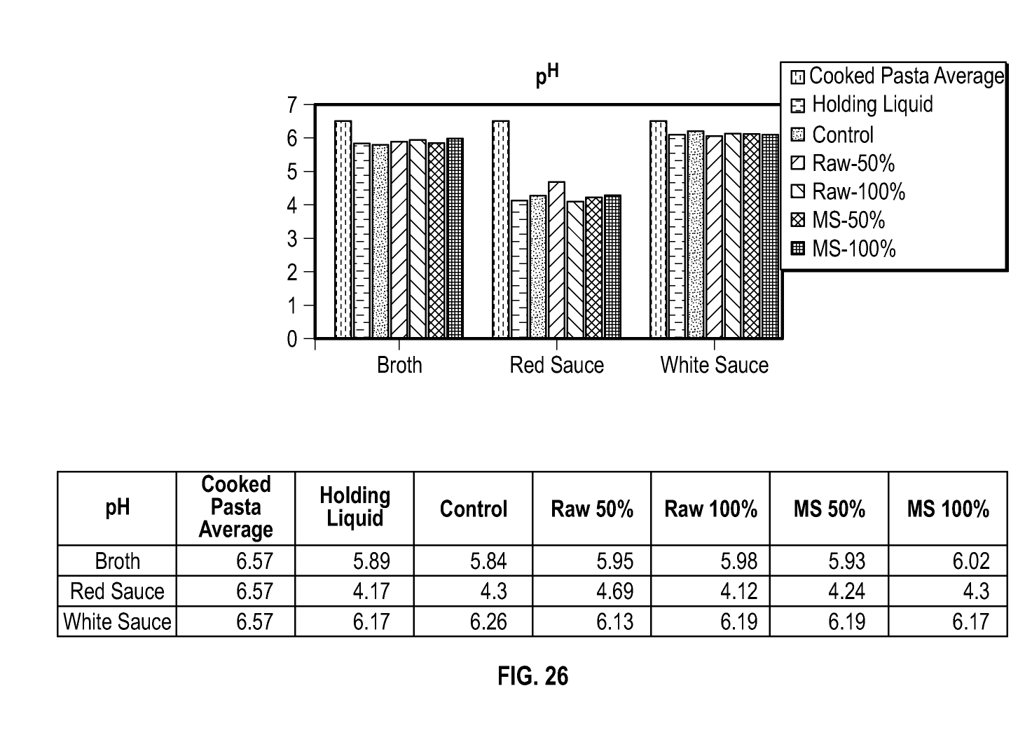

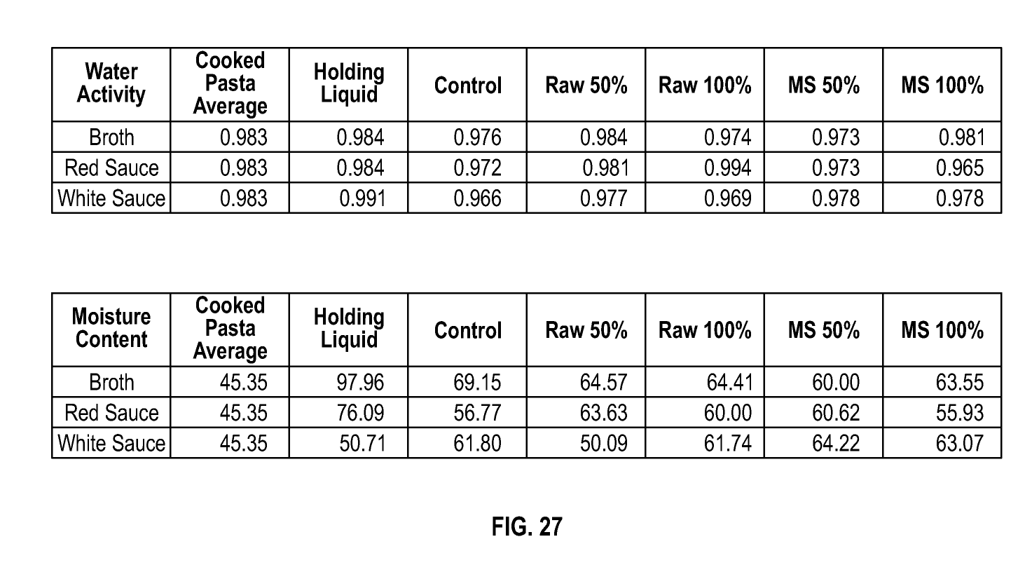

The pasta samples were also tested for pH after hot holds, water activity, and moisture content after hot holds. Water activity was measured using the AquaLab Series 3 water activity meter. A 0.50 g sample of pasta was taken from the hot held pasta. The sample was placed in an AquaLab disposable sample container and put in the water activity meter. The moisture content was measured using the Ohaus MB45 Moisture Analyzer. The aluminum weigh boat was tared while in the pan handler with the lid closed on the moisture analyzer. Approximately 0.50 g of the hot held pasta was weighed for analysis on the moisture analyzer. The lid was closed during testing. The pH of the pasta was measured using the Corning 440 pH meter. About 10.00 g of hot held pasta was combined with about 90.00 mL of distilled water and blended with a hand immersion blender for about 30 seconds. This mixture was mixed for about 2 minutes with a stir bar. Then, the pH will be measured. FIGS. 26 and 27 show the results of these tests. There were no significant differences between pH, water activity and moisture content for the different pasta variables.

Overall, it was observed that SA 50% and SA 100% samples (sodium alginate only, cooked in water) yielded a similar, or slightly more, firm pasta compared to the MS 50% and MS 100% samples after the pasta has been cooked. It was believed that the pasta containing only sodium alginate would result in a softer pasta over time, since the sodium alginate would not have any gelation properties to aid in maintaining structure. It was observed, however, that the pasta containing only sodium alginate has greatly reduced firmness after holding and could not withstand the cooking/holding process.

It was also observed that the time required to cook the pasta to a desired doneness is 2 minutes less for the SA 50% and SA 100% samples compared to the MS 50% and MS 100% samples. The SA 50% and SA 100% samples needed more drying time as well, as compared to the MS 50% and MS 100% samples. The SA 50% and SA 100% samples were also observed to absorb less water than the MS 50% and MS 100% samples. The extended drying time increases the amount of time the pasta is needing to be held and the increased cooking time required for MS 50% and MS 100% can allow for flexibility in preventing overcooking by the user.

The SA w/CL 50% and SA w/CL 100% samples (sodium alginate only, cooked in a calcium lactate bath) also yielded a similar, or slightly more, firm pasta compared to MS 50% and MS 100% samples. The SA w/CL 50% and SA w/CL 100% samples resulted in a firmer cooked pasta compared to the sodium alginate cooked in water samples. Additionally, the time required to cook the pasta to a desired doneness is 1.25-1.5 minutes less for the SA w/CL 50% and SA w/CL 100% samples compared to the MS 50% and MS 100% samples. The SA w/CL 50% and SA w/CL 100% samples were found to absorb less water than the MS 50% and MS 100% samples.

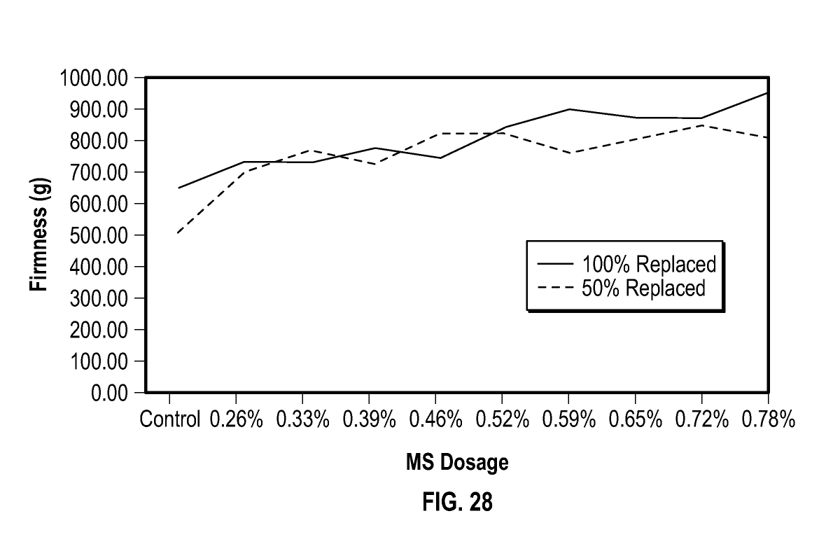

A dose response study was conducted for 50% and 100% egg replacement by increasing the amount of encapsulated calcium lactate from about 0.20 wt % to about 0.8 wt % with corresponding sodium alginate. The calcium lactate values were varied in approximately 0.07 wt % increments and the sodium alginate values were about 0.10 wt % to about 0.40 wt % and varied in approximately 0.04 wt % increments. All of the pasta were cooked to a similar doneness and then tested on the texture analyzer. The pasta was tested for firmness. It was determined that as the dosage of the MS/Sodium Alginate increased the firmness of the pasta for both the 50% and 100% egg replaced also slightly increased. FIG. 28 shows the results of the dose response study. The dose response study illustrates that as the dosage of sodium alginate and encapsulated calcium lactate increase the firmness of the pasta increases. Through the dose response study it was found that the cook time is also extended as dosage increases.

While this disclosure has been particularly shown and described with reference to example embodiments thereof, it will be understood by those skilled in the art that various changes in form and details may be made therein without departing from the scope of the invention encompassed by the appended claims.

We claim:

1. A composition comprising:
(i) an encapsulated calcium salt;
(ii) an alginate; and
(iii) a pasta dough.

2. The composition of claim 1, comprising between about 0.2 wt % and about 0.8 wt % of encapsulated calcium salt.

3. The composition of claim 1, comprising between about 0.1 wt % and about 0.4 wt % of alginate.

4. The composition of claim 1, wherein the calcium salt is encapsulated in a biocompatible encapsulation material.

5. The composition of claim 4, wherein the biocompatible encapsulation material comprises hydrogenated vegetable oil, monoglyceride, diglyceride, triglyceride or combinations thereof.

6. The composition of claim 1, wherein the encapsulated calcium salt does not include a surfactant.

7. The composition of claim 5, wherein the average thickness of the biocompatible encapsulation material is greater than about 0.005 mm.

8. The composition of claim 5, wherein the encapsulated calcium salt is stable up to about 30° C.

9. The composition of claim 1, wherein the encapsulated calcium salt comprises between about 40 wt % and about 60 wt % of biocompatible encapsulation material.

10. The composition of claim 1, wherein the calcium salt is calcium lactate.

11. The composition of claim 1, wherein the alginate is sodium alginate.

12. The composition of claim 1, further comprising one or more additives.

13. A method comprising:
(i) adding an encapsulated calcium salt to a pasta dough,
(ii) adding an alginate to the pasta dough,
(iii) mixing the pasta dough wherein the encapsulated calcium salt and alginate are substantially uniformly distributed throughout the pasta dough to form a mixed pasta dough; and
(iv) effecting release of the calcium salt from encapsulation and crosslinking with the alginate.

14. The method of claim 13, further comprising forming a finished, dried pasta, wherein the finished, dried pasta is heated to a temperature greater than about 30° C.

15. The method of claim 14, wherein the finished, dried pasta is heated for at least about 7 minutes.

16. A pasta composition comprising a crosslinked alginate substantially uniformly distributed throughout the pasta.

17. The pasta composition of claim 16, wherein the pasta has a firmness of greater than about 500 grams.

18. The pasta composition of claim 16, wherein the pasta has a work of shear value of greater than about 25 grams/sec.
